(19) United States
(12) Patent Application Publication
(10) Pub. No.: US 2004/0035327 A1
(43) Pub. Date: Feb. 26, 2004

(54) Insulation material and method for coating nozzles, pouring spouts, pouring-stream protective tubes and similar tools for casting or converting melts

(76) Inventor: Gunther Schrick, Haltern (DE)

Correspondence Address: CANTOR COLBURN, LLP, 55 GRIFFIN ROAD SOUTH, BLOOMFIELD, CT, 06002

(21) Appl. No.: 10/297,040

(22) PCT Filed: May 31, 2001
(86) PCT No.: PCT/EP01/06186

(30) Foreign Application Priority Data
May 31, 2000 (EP) 00111606.0

(51) Int. Cl. B05D 1/02; B05D 5/00; C04B 7/32

(52) U.S. Cl. 106/692; 427/243; 427/421; 252/62; 501/125

(57) ABSTRACT

The invention relates to insulating material and to a method for coating nozzles, pouring spouts, pouring-stream protective tubes and similar tools for casting or converting melts, especially molten baths used in the steel industry. The aim of the invention is to produce a low-cost insulation which does not damage people's health, is not harmful to the environment, is thermally stable at operating temperatures especially at temperatures of over 1200° C.—and which exhibits low thermal conductivity. The insulation material is a mixture of at least one raw material and at least one binding agent. Said mixture forms a microporous structure once it has hardened. The surface of a workpiece for forming the insulation is at least partially coated with the insulating material.

The present invention concerns an insulation material and a method for coating linings, pouring pipes, pouring jet protection pipes and the like for casting or transfer of melts, especially fused metals used in the steel industry.

In casting melts, these are usually passed from a distributor vessel or a holding furnace through a pouring pipe to the mold or the ingot mold. Depending upon the melt, especially with molten metals of different materials such as steel, aluminum or the like, and depending upon the casting method, pouring pipes of the most varied materials are used. Thermal shock reactions and solidification of melts are a problem in the melt flow that arise through heat radiation in the area of the linings, pouring pipes and similar workpieces during casting or transferring melts. Thermal shock reactions and solidification are, moreover, triggered in particular due to temperature fluctuations caused by heat radiation of the workpieces.

Thermal shock reactions and solidification, moreover, condition the necessity of cleansing the melts used for casting, which usually takes place using oxygen lances and the like for flame cleaning melts and baked-on metals, for example, steel or aluminum. Cleaning the workpieces used to cast melts by flame cleaning has, moreover, a negative effect on the durability of the workpieces.

Providing linings, pouring pipes, pouring jet protection pipes and similar workpieces for casting and transferring melts with insulation on the outside to reduce thermal shock reactions and solidification is known. The insulation applied to the exterior of the workpieces is supposed to minimize thermal shock in the event of heating up and prevent solidification.

Up until now, insulation fiber materials have been used which the legislator classified for health reasons as category 2 carcinogens with substitution requirement. Some non-classified substitute materials, especially substitute materials with a low clay fiber component, show decomposition and melting manifestations at temperatures over 1200° C. which destroy, nonetheless diminish, the insulation action. In addition, some of the decomposition products pose health risks. Most substitute materials can only be used up to ca. 1000° C.

More recent casting methods used in the steel industry, for example CSP technology, require insulation for heating up over 1200° C., in particular because thermal shock reactions and solidification with these methods rapidly lead to casting breakage since the liquid steel is poured through slots with a thickness from 15 mm to 30 mm in the linings.

Furthermore, the new casting methods used in the steel industry presuppose complex shapes for the workpieces used for casting and transferring melts which restrict the thickness of the insulation.

In view of this state of the art, the object of the invention is based upon furnishing an insulation material and a method for coating linings, pouring pipes, pouring jet protection pipes and like materials for casting and transferring melts, especially of melts used in the steel industry, which makes it possible to construct an economical insulation harmless to health and environment which is thermally stable even at temperatures above 1200° C. and has a low heat conductivity.

For the technical accomplishment of the objective, an insulation material for coating linings, pouring pipes, pouring jet protection pipes and similar workpieces for casting and transferring melts, especially molten metals used in the steel industry, is furnished with the present invention, consisting of a mixture of at least one raw material, and at least one bonding agent which forms a microporous structure after hardening.

Underlying the invention is the knowledge that beside the material property of the pure substance of an insulation, for example 99.9% clay, the structure in which the insulation is present, for example, with regard to hollow spaces, grain size distributions and the like, also has a basic influence upon thermal stability and heat conductivity. It is apparent that the heat conductivity of insulation rather generally declines with increasing porosity. The reason is that heat losses basically take place through heat radiation, especially at higher temperatures. The greater the porosity of the insulation is, the more the heat radiation has impeding grain limits.

The use of an advantageously microporous raw material in accordance with the invention therefore makes possible the formation of a thermally stable insulation with reduced heat radiation and therewith less heat conductivity, especially at temperatures over 1200° C. In addition, the use of a microporous raw material allows an economical construction of an insulation that is otherwise harmless to health and the environment. Moreover, it is sufficient in accordance with the invention if the mixture forms a microporous structure, at least after hardening, for example, by drying or the like. Furthermore, the raw material, as well as the bonding agent itself, represent a mixture or a bonding system.

SLA-92, in a grain size of up to 1.0 μm and in amounts of ca. 65 to 98% by weight, preferably in amounts of ca. 90% by weight, has proven itself as an especially suitable microporous raw material. SLA-92 is a calcium hexa-aluminate (CaO×6 Al₂O₃ or CA₈) with a raw density of 0.75 g/cm³. SLA-92 contains ca. 92% Al₂O₃ and ca. 7.5% CaO, SLA-92 has a high porosity of usually 75% and a pore radius of 0.5 to 2.5 μm.

The use of a cement as a bonding agent, preferably of CA-270, has proven advantageous in amounts of ca. 2 to 35% by weight, preferably ca. 10% by weight. CA-270 is a calcium aluminate cement of the ALCOA Company. Besides cement, however, other bonding systems, especially phosphate bondings, artificial resin bondings, water glass and the like, as well as organic bonders such as acrylic glues, polyester resins, epoxy resins or similar systems which are cracked off after setting.

In accordance with a further advantageous refinement of the invention, the mixture includes additives for increasing green stability as well as additives for improving setting behavior.

On the part of the method, the surface of a workpiece for casting or transferring melts is at least partially coated with the insulation material.

Advantageously, the insulation material is prepared for coating with water, whereby water is introduced into the insulation material in amounts which make possible spraying on or application, especially filling, the insulation material on the workpiece. The water component is oriented toward the coating method. For spraying, the mixture is made watery for spraying by appropriate water addition. For use as filling material, a past is produced by slight water administration, which is made more or less viscous as a function of the desired or required layer thickness. In accordance with an especially advantageous refinement of the invention, the insulation material is applied in variable layer thicknesses on the workpiece. Thus the coating can assume a course with respect to its layer thickness on the workpiece, for example from 3 mm to 6 mm or 9 mm and back to 3 mm or the like. Consequently, insulation layers contoured in their thickness can be formed according to use and insulation requirements in the workpiece. In an especially preferred refinement of the invention, the insulation is applied to the workpiece in a layer thickness of ca. 1.0 mm. After providing the workpieces with the insulation material, the coating is dried, preferably at a temperature of 100° C.

The insulation material and the coating so formed are suitable for linings, pouring pipes, pouring jet protection pipes and similar workpieces for casting or transferring melts, especially also for steel or ceramic filling chambers as well as steel or ceramic standpipes which are suited for casting molten aluminum.

In an advantageous refinement of the invention, the workpiece is provided with the oxidation-inhibiting coating before coating with insulation material. The oxidation-inhibiting coating moreover melts upon heating or burning and forms a glass phase. Through the glass phase, the oxidation inhibiting coating forms a sort of mediating layer which guarantees that the insulation coating is securely joined with the workpieces to be coated for casting or transferring melts. This is especially significant for workpieces for casting or transferring steel melts in the extrusion process, which usually consist of clay graphite, stabilized or partially stabilized zirconium oxide graphite, as well as SiC, SiO₂ or Si in metallic form in addition to as a rule secret manufacture-specific additives. With these workpieces, it is a problem of whether to apply the insulation coating directly to the surface of the workpiece or to spray it on, since in these cases a sufficient compound stability between insulation coating and the coated workpiece is not realizable, at least not in the form that a functional capacity of the coating exists for at least 10 h.

In an advantageous refinement of the invention, the oxidation-inhibiting coating is formed by a typical commercial wall hardener or cleaning hardener which is applied to the surface of the workpiece, for example by spraying or filling. The wall hardener or cleaning hardener is moreover in standard use in the construction industry. In accordance with an especially advantageous refinement of the invention, a commercially available fireproof glue is used for the oxidation-inhibiting coating which advantageously promotes the formation of glass phases. A glue consisting of sodium silicate and clay which has a use temperature of up to 1200° C. has proven to be especially suitable. Moreover, already appropriately oxidation-inhibiting glazed workpieces that can be obtained commercially can also be used and be provided with a microporous coating. The microporous coating can furthermore be arranged on the oxidation-inhibiting coating or glaze, or partially loosen this and form the microporous layer with the latter.

Advantageously the oxidation-inhibiting coating is dried before coating of the workpieces with insulation material, preferably at a temperature of 100° C.

The oxide-inhibiting coating melts during heating the workpiece up during the first use of the so coated workpieces depending upon the oxidation-inhibiting materials in a temperature range from ca. 550° C. to ca. 1200° C. The glass phase arising in this connection can then react with the CA₆ structure of SLA-92 and partially dissolve on. In this way, an outstandingly adhering insulation coating arises. The reaction is temperature-dependent and forms a very well adhering insulation layer at high temperatures above 1000° C. which is at the same time oxide-inhibiting.

Advantageously this reaction is amplified with additional use of fireproof glue owing to the increased formation of glass phases. The fireproof glue brings about the formation of glass phases at temperatures above 1260° C. as well as at temperatures below 1000° C.

It has proven appropriate to add underneath alkalis and/or boric acid or their derivatives to the fireproof glue serving as a mediator at temperatures on the surface of the workpiece of ca. 900° C. In this way, it is guaranteed that melted on glass phases are formed already at ca. 550° C. so that the additionally oxidation-inhibiting insulation coating can also form at low temperatures. In addition, the advantage that the viscosity of the glass phases formed with rising temperature increases is associated with the administration of boric acid, and thus the adhesion and oxidation inhibition further improve.

In addition to this, the insulation layer can be adapted in accordance with the requirements of the workpieces for casting or transferring melts independently of the oxidation-inhibiting layer through the addition of alkalis or boric acid or its derivatives advantageously in a manner such that a new insulating oxidation-inhibiting layer is formed. In an especially preferred refinement of the invention, boric acid or boric acid salts are used in amounts up to 30% by weight. Nonetheless, amounts below 10% by weight and over 30% by weight are also suited, depending upon use and insulation needs.

The coating newly forming in accordance with the invention almost furnishes a barrier layer between the surrounding atmosphere and the fireproof material and consequently fulfills the purpose of suppressing oxidation since the porosity of the body is reduced. In this way, this coating is especially suited for use on packing rods of clay graphite owing to the oxidation-inhibiting action.

1. Insulation material for coating linings, pouring pipes, pouring jet protection pipes and similar workpieces for casting or transferring melts, especially of molten metals used in the steel industry, consisting of a mixture of at least one raw material and at least one bonding material which forms a microporous structure at least after hardening.

2. Insulation material according to claim 1, characterized in that the raw material is microporous.

3. Insulation material according to claim 2, characterized in that the microporous raw material is SLA-92.

4. Insulation material according to one of claims 1 to 3, characterized in that the microporous raw material has a mean grain size of 1.0 μm.

5. Insulation material according to one of the preceding claims, characterized in that the microporous raw material is used in amounts of ca. 65 to 98% by weight, preferably in amounts of ca. 90% by weight.

6. Insulation material according to one of claims 1 to 5, characterized in that the bonding agent is cement, preferably CA-270.

7. Insulation material according to one of claims 1 to 6, characterized in that the bonding agent is used in amounts of ca. 2 to 35% by weight, preferably ca. 10% by weight.

8. Insulation material according to one of claims 1 to 7, characterized in that the mixture furthermore includes additives for increasing green stability.

9. Insulation material according to one of claims 1 to 8, characterized in that the mixture furthermore includes additives for improving setting behavior.

10. Method for coating linings, pouring pipes, pouring jet protection pipes and similar workpieces for casting and transferring melts, especially of molten metals used in the steel industry, whereby the surface of a workpiece is at least partially coated with an insulation material according to one of claims 1 to 9.

11. Method according to claim 10, characterized in that the insulation material is prepared for coating with water.

12. Method according to claim 11, characterized in that water is added to the insulation material in amounts which make possible spraying the insulation material on the workpiece.

13. Method according to claim 11, characterized in that water is added to the insulation material in amounts which make possible an application of the insulation material to the workpiece.

14. Method according to one of the preceding claims, characterized in that the insulation material is sprayed onto the workpiece.

15. Method according to one of the preceding claims, characterized in that the insulation material is applicable to the workpiece with a trowel.

16. Method according to one of claims 10 to 15, characterized in that the insulation material is applied in variable layer thicknesses, preferably variable over a workpiece to be coated.

17. Method according to one of claims 10 to 16, characterized in that the insulation material is applied in a layer thickness of ca. 1.0 mm.

18. Method according to one of claims 10 to 17, characterized in that the coating of insulation material is dried, preferably at a temperature of 100° C.

19. Method according to one of claims 10 through 18, characterized in that the workpiece is provided with an oxidation-inhibiting coating prior to coating with insulation material.

20. Method according to claim 19, characterized in that the oxidation-inhibiting coating is comprised of a commercially available wall or cleansing hardener.

21. Method according to claim 19 or claim 20, characterized in that the oxidation-inhibiting coating includes commercially available fireproof glue.

22. Method according to one of claims 19 to 21, characterized in that the oxidation-inhibiting coating is mixed with alkalis, boric acid or boric acid derivatives.

23. Method according to claim 22, characterized in that alkalis, boric acid or boric acid derivatives are added to the oxidation-inhibiting coating.

24. Method according to one of the preceding claims, characterized in that the oxidation-inhibiting coating is dried before coating with insulation material, preferably at a temperature of 100° C.
